(19) United States
(12) Patent Application Publication
(10) Pub. No.: US 2006/0066166 A1
(43) Pub. Date: Mar. 30, 2006

(54) Rotor body for the rotor of an electric machine and a method for the manufacture of a rotor body

(76) Inventors: Willi Hauger, Villingen-Schwenningen (DE); Helmut Hans, Sankt Georgen (DE)

Correspondence Address: Mark C. Comtois;DUANE MORRIS LLP, Suite 700, 1667 K Street, N.W., Washington, DC, 20006, US

(21) Appl. No.: 11/225,062

(22) Filed: Sep. 14, 2005

(30) Foreign Application Priority Data
Sep. 29, 2004 (DE) 10 2004 047 311.0

(51) Int. Cl. H02K 21/12

(52) U.S. Cl. 310/156.53

(57) ABSTRACT

A rotor body for the rotor of an electric machine having at least one rotor lamination which is formed in the way of a strip having a series of projections along a longitudinal edge of the strip and bent in the plane of the strip to form a ring, the projections extending inwards after the rotor lamination has been bent and the rotor lamination having a substantially unbroken outside edge.

### FIELD OF THE INVENTION

The invention relates to a rotor body for the rotor of an electric machine and a method for the manufacture of a rotor body. The rotor body according to the invention can be used in many types of electric machines, such as DC motors and generators.

### BACKGROUND OF THE INVENTION

A preferred field of application for the invention is in brushless DC motors and other permanent magnet motors. In such motors, it is basically known to provide permanent magnets on the outside circumference of a rotor back yoke or to embed them in the back yoke. The invention can further be employed in electric motors and generators that can be configured as inner rotor motors or as outer rotor motors. Electric motors having an inner rotor motor configuration have a rotor back yoke that is mounted onto a shaft and one or more permanent magnets that are mounted onto the rotor back yoke or embedded in the back yoke. The motors additionally comprise a stator arrangement consisting, for example, of a number of stacked metal laminations which form an annular stator back yoke from which pole shoes protrude inwards. Phase windings are mounted on the pole shoes. The rotor arrangement is inserted coaxially into the stator arrangement. In the case of an outer rotor motor configuration, the rotor arrangement encloses the stator coaxially.

The invention can be applied in particular to an inner rotor motor with a rotor arrangement having embedded permanent magnets.

FIG. 8 shows the basic construction of an electric motor having a housing 100 in which a stator arrangement 112, a rotor arrangement 114 and bearings 116, 118 to rotatably support the rotor arrangement are accommodated. The stator arrangement 112 comprises stacked metal laminations 120 and windings 122 and defines an inner space into which the rotor arrangement 114 is inserted. The rotor arrangement 114 includes the shaft 126, an iron back yoke 128 and permanent magnets. The bearings 116, 118 supporting the rotor arrangement can be integrated into a flange 132 of the motor housing 100. FIG. 8 serves to explain the basic construction of an electric motor. As mentioned at the outset, in its preferred application, the invention relates to a rotor back yoke for this kind of electric motor, the permanent magnets being embedded in the rotor back yoke.

Rotors having embedded magnets are generally known in the prior art. A rotor configuration having a multi-polar, spoke-like arrangement of radially extending embedded magnets is shown, for example, in EP 0 691 727 A1. This publication shows a number of permanent magnets which are inserted into slots formed in the rotor body allowing the permanent magnets to be inserted into the rotor body from the outside.

In the prior art, a rotor body or rotor back yoke to receive the permanent magnets is frequently formed from a stack or packet of laminations, each back yoke lamination being annular and having slots or recesses to receive the permanent magnets. The rotor body is mounted onto a shaft in a pressfit, for example. It is also known to injection-mold the rotor body and the shaft in a positive fit with plastics.

The problem arising in the manufacture of this kind of rotor back yoke is that in punching out the individual back yoke laminations there is considerable waste. What is more, due to the preferred magnetic direction of the laminations, magnetic asymmetry is produced which can have a disruptive effect of the operation of the motor.

It is the object of the invention to provide a rotor body for the rotor of an electric machine which can be manufactured in a material-saving and low-cost way.

### SUMMARY OF THE INVENTION

The invention provides a rotor body for the rotor of an electric machine having at least one rotor lamination which is formed in the way of a strip having a series of projections along a longitudinal edge of the strip and bent in the plane of the strip to form a ring, the projections extending inwards after the rotor lamination has been bent and the rotor lamination having a substantially unbroken or continuous outside edge. The construction according to the invention makes it possible to build up the rotor body from laminations which originally take the form of a length of strip that can be punched out from sheet metal with few off cuts. The rotor body preferably takes on the function of a rotor back yoke as well. Since, according to the invention, this back yoke is made from a length of sheet-metal strip, the rotor back yoke has a uniform preferred magnetic direction in a radial direction. To ensure that, after it is bent, the strip forms an annular rotor body having slots for the insertion of permanent magnets, the projections are arranged along the longitudinal edge of the strip with a spacing in between and given a tapered form. By correctly dimensioning the taper, the sides of two adjacent projections lie parallel to each other after the lamination has been bent and thus preferably define a slot to receive a permanent magnet. However, the projections can also be arranged and shaped in such a way that after the rotor lamination has been bent, a largely unbroken rotor body is produced, the permanent magnets then being conveniently mounted on the outer circumference of the rotor body. In this version, the projections are arranged next to each other along the longitudinal edge without a spacing in between.

In a preferred embodiment, the rotor lamination is designed in such a way that two rotor laminations can be punched out of one sheet-metal strip, the laminations lying opposite each other and the projections engaging into each other. This results in an optimized material utilization.

After the rotor laminations have been punched out, as a rule they are first formed into a lamination stack and then bent to form a rotor body and sealed at a joint by laser welding, for instance. This results in an annular rotor body having an unbroken outside circumference and open slots towards the inside for the insertion of permanent magnets. The individual rotor laminations can be arranged with respect to each other so that their joints are aligned or are aligned in groups or that the joints of all the rotor laminations are staggered with respect to each other. The rotor laminations are preferably made from a magnetically active material so that the rotor body also acts as a back yoke. However, the laminations can also be made of a non-magnetic material in order to form a magnetically non-active rotor body, provided that the magnetization of the permanent magnets allows this, for example, where Halbach magnetization is used.

The rotor body according to the invention is preferably mounted on a shaft in that it is wound directly about the shaft. The outer circumference of the shaft can be splined, the splines engaging with the projections on the rotor body. It is also possible for the shaft to be treated in some other way in order to ensure that the rotor body adheres to the shaft; for example, by roughening it, using outsert technology or knife-edges. Splining can be worked into the shaft or formed on a member which is mounted on the shaft or integrally formed with the shaft.

### SHORT DESCRIPTION OF THE DRAWINGS

The invention is described in more detail below on the basis of preferred embodiments with reference to the drawings. In the embodiments described, the rotor body according to the invention forms a magnetic rotor back yoke and is built up of magnetically active metal laminations. A person skilled in the art, however, would be aware that the basic principles of the present invention can be applied to a non-magnetic rotor body made from a different material.

The figures show:

FIG. 1a two back yoke laminations used to fabricate the rotor back yoke according to the invention which is punched from a sheet-metal strip;

FIG. 1b a single punched out back yoke lamination taking the form of a strip;

FIG. 2 the back yoke lamination of FIG. 1b after it has been bent to form a ring;

FIG. 3 a stack of several back yoke laminations in an unwound state;

FIG. 4 a schematic view of the rotor back yoke according to the invention in an unwound state and also being wound about a shaft;

FIG. 5 a rotor back yoke according to the invention that is mounted on a shaft;

FIG. 6a a side view of a shaft to receive the rotor back yoke according to the invention;

FIG. 6b a sectional view through the shaft of FIG. 6a;

FIG. 7 a perspective view of an alternative embodiment of the shaft to mount a rotor back yoke; and

FIG. 8 a schematic view of an electric motor in which the rotor back yoke according to the invention can be employed.

### DETAILED DESCRIPTION OF PREFERRED EMBODIMENTS

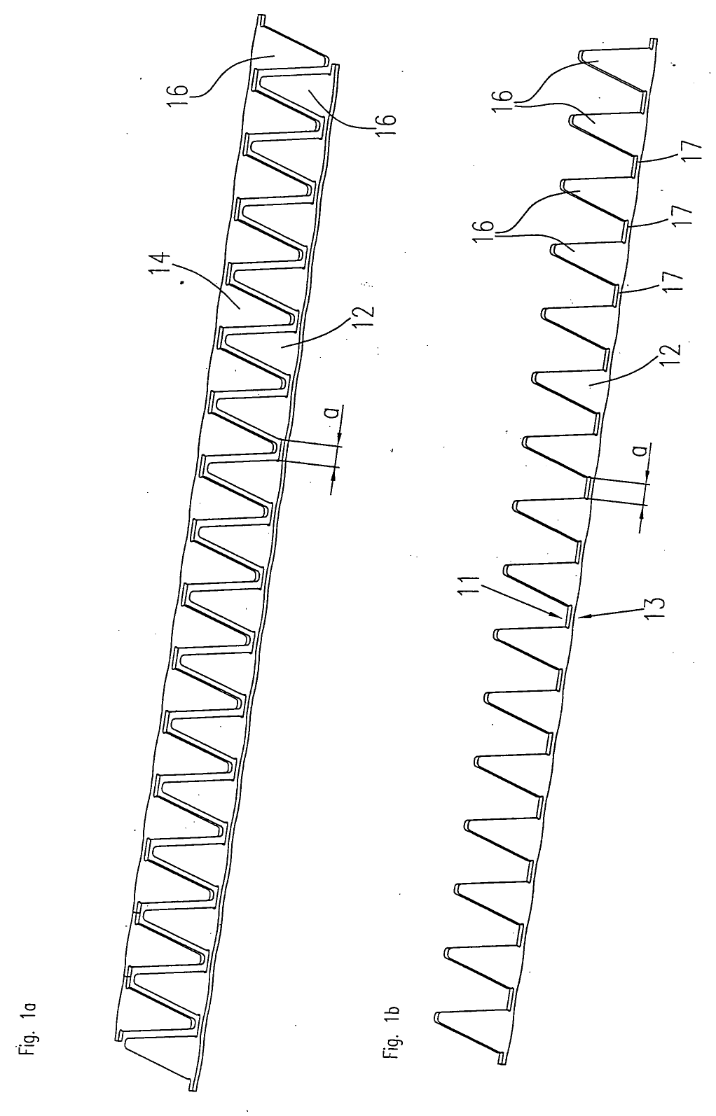

FIG. 1a shows two back yoke laminations 12, 14 that have been punched from one sheet-metal strip. FIG. 1b shows a single back yoke lamination 12 that has been punched from the sheet-metal strip. Each back yoke lamination 12, 14 is formed in the way of a strip having a series of projections 16 along a longitudinal edge 11 of the strip 12 or 14. The projections 16 are arranged along the length of the strip at a regular spacing and have a tapered shape, as illustrated in FIGS. 1a and 1b. The taper of each of the projections 16 is connected to adjacent projections 16 at its base via bridges 17. The longitudinal edge 13 of the strip 12 or 14 opposite the projections 16 preferably forms a straight outside edge. Slight deviations from a straight line, however, can also be provided in order, for instance, to influence torque fluctuations in a specific way. It is possible, for example, to make the longitudinal edge 13 of the strip wavy or give it radii in order to obtain a back yoke member whose outside circumference has concave and/or convex sections. As can be seen from FIG. 1a, each back yoke lamination 12, 14 can be punched from a sheet-metal strip or thin sheet metal with minimum waste.

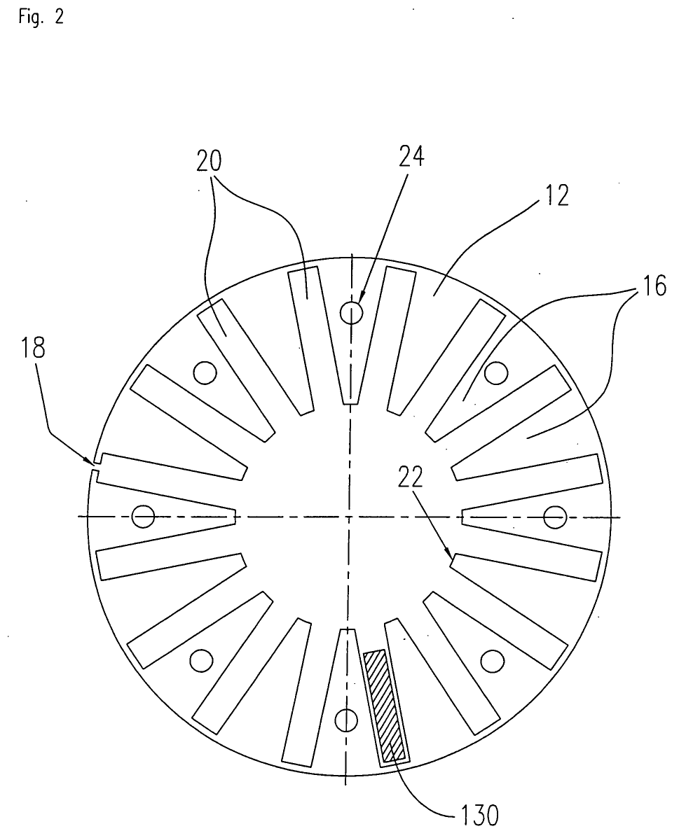

According to the invention, the back yoke lamination 12, as shown in FIG. 2, is bent in the plane of the strip to form a ring whose profile corresponds substantially to the lamination design of a conventional rotor back yoke. The ring, however, has a gap 18 which can be closed, for example, by welding, particularly by laser welding. The tapered projections 16 are so dimensioned that when the back yoke lamination 12 has been bent to form a ring, slots or recesses 20 having substantially parallel sides are produced in which the permanent magnets 130 can be inserted. When the back yoke is mounted onto a shaft, the tips 22 of the projections 16 can engage with splines or recesses in the shaft. It is possible to join the back yoke member and the shaft in a positive fit or to give the shaft a coating that has a high coefficient of friction which interacts with the tips 22 of the projections 16. Splining for the rotor back yoke can be directly integrated in the shaft and can be made by using cold forming technology or by material removal. For mass production, cold forming technology would be more economical. It is also possible to injection-mold a splined member for the rotor back yoke directly onto the shaft, using, for example, outsert technology. In this case, it is expedient to first roughen the surface of the shaft by giving it, for example, a knurl or knife edges, or to prime the shaft with a polyester film to improve the adhesion of the splined body without the need for any mechanical roughening.

Moreover, in FIG. 2, raised points 24 are indicated on the back yoke lamination 12 that are used as connection points for its connection to other back yoke laminations to build up a lamination stack.

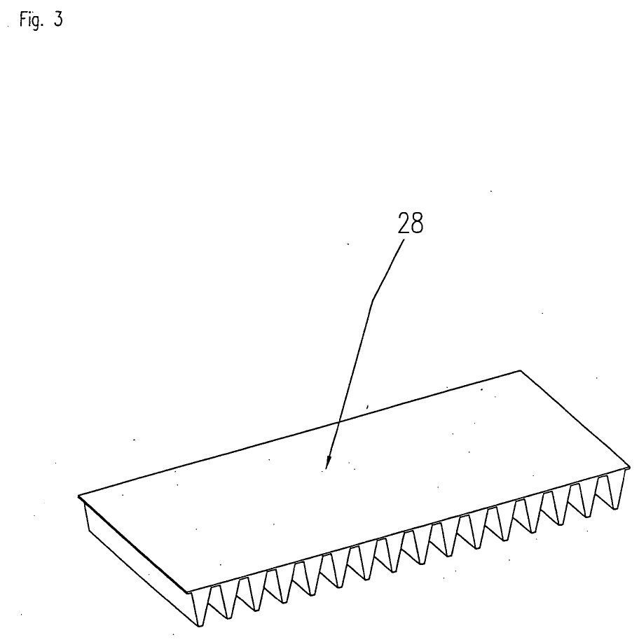

FIG. 3 shows an embodiment of the rotor back yoke 28 according to the invention in which the individual back yoke laminations in an unwound state are stacked to form a lamination stack and joined to each other before the rotor back yoke is bent to form a closed ring. In an alternative embodiment, the individual back yoke laminations can each be bent to form a ring and then joined together in a lamination stack. After the ring has been closed, it is possible to weld the individual laminations or the entire lamination stack at the joint thus formed.

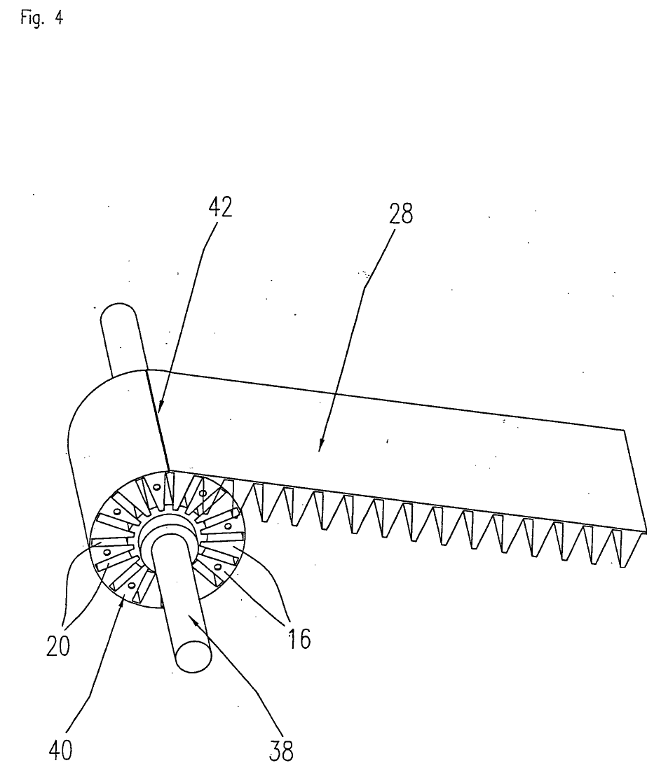

FIG. 4 shows an embodiment in which the rotor back yoke 28, as in FIG. 3, is first joined together to form a lamination stack and then wound onto a shaft 38 as shown at 40. The shaft has splines or similar items that engage with the tips of the projections 16 on the rotor back yoke 40 in order to connect the rotor back yoke to the shaft 38 in a positive fit. The rotor back yoke 40 is sealed at a joint 42 by welding, for example. In another embodiment, the wound rotor 40 can be held together by a pipe that is slid over the rotor body, or by end caps, clamping rings or suchlike. Permanent magnets can either be placed into the slots or recesses 20 formed in the rotor back yoke 40 before the rotor back yoke is wound onto the shaft 38 or inserted afterwards in an axial direction. The correct choice of taper for the projections 16 makes it possible, after the rotor back yoke has been bent, for the slots or recesses 20 to be given preferred parallel sides in order to receive the permanent magnets.

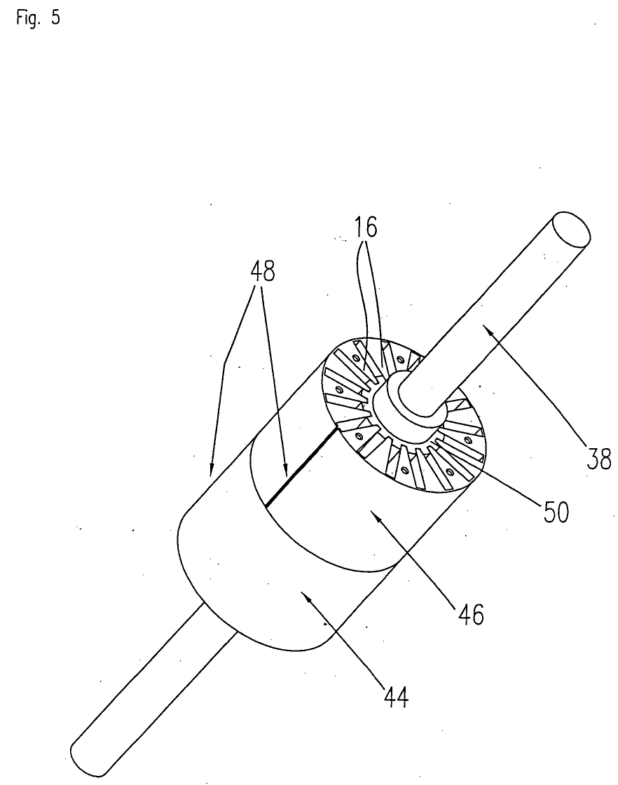

FIG. 5 shows an embodiment of the invention in which a first group of back yoke laminations forms a first back yoke section 44 and a second group of back yoke laminations forms a second back yoke section 46. It is possible to wind the back yoke sections 44, 46 one after the other onto the shaft 38 or, alternatively, to first close each of the back yoke sections 44, 46 to form a ring, to then join them together and finally to mount the entire rotor back yoke onto the shaft. The joints 48 of each back yoke section 44, 46 can be arranged with respect to each other so that they are not aligned. If two back yoke sections are provided, it is best if the joints are arranged at an offset of 180° in order to achieve an even distribution of the rotor weight. This arrangement additionally produces symmetric magnetic field geometry. Instead of a welded joint, provision can also be made for the back yoke laminations to be closed at the joints using a pipe, end caps, clamping rings or suchlike.

The rotor back yoke illustrated in FIG. 5 is held on the shaft 38 via a member 50 having splines into which the projections 16 engage. This member 50 can, for example, be injection-molded directly onto the shaft 38 or formed integrally with the shaft as mentioned above.

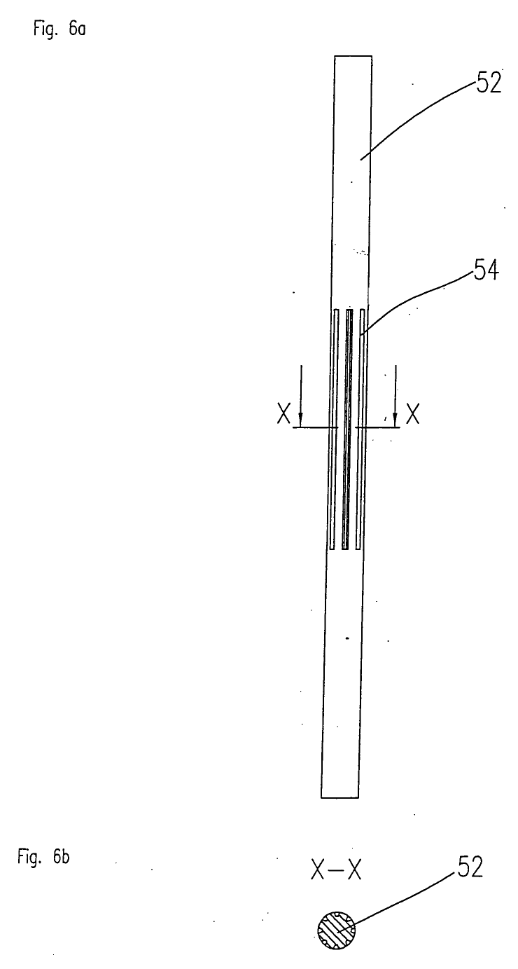

FIG. 6a and 6b show a side view of and a sectional view through a shaft 52 on which the rotor back yoke according to the invention can be mounted. As illustrated in the figures, grooves 54 can be formed on the shaft 52 with which the projections 16 can be made to engage. The rotor back yoke according to the invention has the advantage that it can be directly wound onto a shaft of the kind shown in FIG. 6a, 6b so that the tips 22 of the projections 16 can engage into the grooves 54. The rotor back yoke can thus be mounted without any problems even if the diameter of the spline bottom on the shaft is smaller than the outside diameter of the shaft.

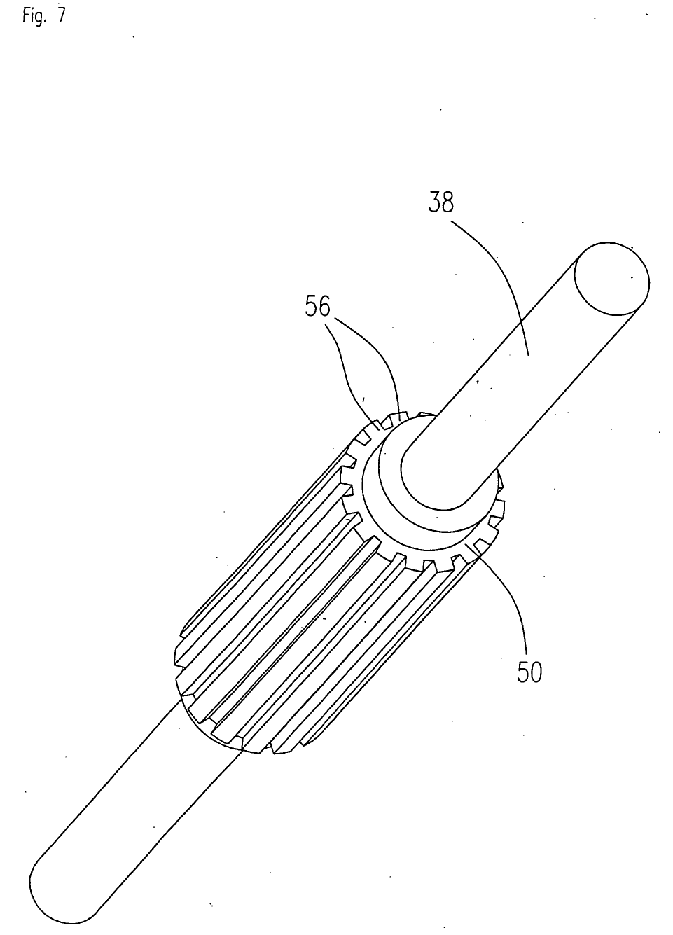

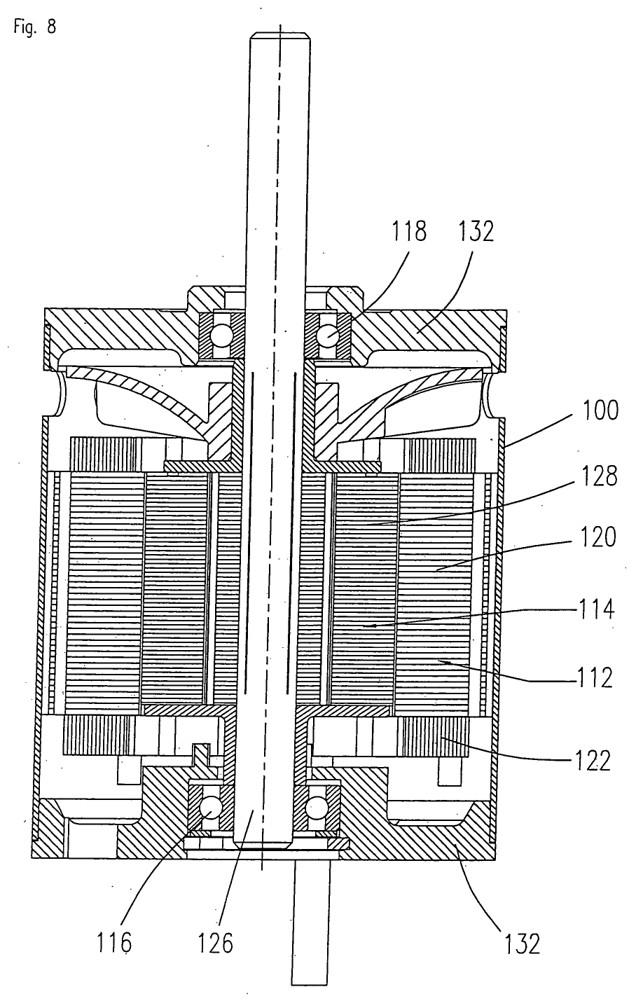

In an alternative embodiment shown in FIG. 7, a member 50 having splines 56 is mounted on the shaft 38, the splines being connected to the projections 16 of the back yoke member in a positive fit. The member 50 can be made, for example, out of plastics and injection-molded onto the shaft 38 or formed integrally with the shaft 38.

The rotor body according to the invention has the great advantage that it can be made from rotor laminations which have the same direction of rolling with hardly any waste. The rotor laminations are first made in the form of a strip and then bent into a ring in the plane of the strip. Consequently, each annular rotor lamination has the same preferred direction of magnetization or, in other words, there is the same preferred magnetic direction of the rotor material in each rotor region. This results in the rotor body having isotropic, homogeneous material properties which means a smoother running motor. The rotor body according to the invention has the added advantage that it can be connected without any problems in a positive fit to a shaft that has splines to receive the tips of the projections when the spline bottom has a smaller diameter than the outside diameter of the shaft.

The characteristics revealed in the above description, the claims and the figures can be important for the realization of the invention in its various embodiments both individually and in any combination whatsoever.

### IDENTIFICATION REFERENCE LIST

12,14 back yoke laminations, rotor laminations
11,13 longitudinal edges
16 projections
17 bridges
18 gap
20 slots or recesses
22 tips
24 raised points
28 rotor back yoke, rotor body
38 shaft
40 rotor back yoke, rotor body
42 joint
44,46 back yoke section
48 joints
50 member
52 shaft
54 grooves
56 spline
100 housing
112 stator arrangement
114 rotor arrangement
116,118 bearings
120 sheet metal
122 windings
126 shaft
128 iron back yoke
130 permanent magnets
132 flange

1. A rotor body for the rotor of an electric machine having
at least one rotor lamination (12, 14) which is formed in the way of a strip having a series of projections (16) along a longitudinal edge (11) of the strip and bent in the plane of the strip to form a ring, the projections (16) extending inwards after the rotor lamination (12, 14) has been bent and the rotor lamination having a substantially unbroken outside edge (13).

2. A rotor body according to claim 1, wherein the projections (16) are designed in such a way that the bent rotor lamination (12, 14) forms a ring having recesses (20) to receive the magnets, the recesses being formed between the projections (16) and being open radially towards the inside and closed towards the outside.

3. A rotor body according to claim 1, wherein the projections (16) are arranged at a regular spacing with respect to each other along the longitudinal edge (11) and that they have a tapered shape.

4. A rotor body according to claim 1, wherein the rotor lamination (12, 14) is sealed at a joint (42).

5. A rotor body according to claim 4, wherein a plurality of rotor laminations (12, 14) are stacked in an axial direction of the rotor.

6. A rotor body according to claim 5, wherein the plurality of rotor laminations (12, 14) are stacked in such a way that the joints (48) of the various rotor laminations (12, 14) are aligned.

7. A rotor of an electric machine having a shaft (38) and a rotor body (40) comprising at least one rotor lamination (12, 14) which is formed in the way of a strip having a series of projections (16) along a longitudinal edge (11) of the strip and bent in the plane of the strip to form a ring, the projections (16) extending inwards after the rotor lamination (12, 14) has been bent and the rotor lamination having a substantially unbroken outside edge (13), wherein the rotor body (40) is wound about the shaft (38; 52), that the shaft (38; 52) has splines (54; 56) on its outside circumference and the projections (16) of the rotor body (40) engage with the splines (54; 56) of the shaft (38; 52).

8. A rotor according to claim 7, wherein the splines (54; 56) are integrated into the shaft (38; 52) or are formed on a member (50) that is mounted on the shaft (38; 52).

9. A method for the manufacture of a rotor body for the rotor of an electric machine having the following procedural steps:
Providing at least one rotor lamination (12, 14) that is formed in the way of a strip having a series of projections (16) along the longitudinal edge (11) of the strip (12, 14);
Bending the rotor lamination (12, 14) in the plane of the strip to form a ring, the projections (16) extending inwards after bending and the ring having a substantially unbroken outside edge.

10. A method according to claim 9, wherein the rotor lamination (12, 14) bent to form a ring is sealed at a joint (42).

11. A method according to claim 10, wherein a plurality of rotor laminations (12, 14) are stacked in an axial direction of the rotor to form a lamination packet.

12. A method according to claim 11, wherein the plurality of rotor laminations (12, 14) are stacked in such a way that the joints (48) of the various rotor laminations (12, 14) are aligned.

13. A method according to claim 9, wherein two rotor laminations (12, 14) are punched from a sheet-metal strip (10), the rotor laminations (12, 14) lying opposite each other and the projections (16) interlocking with each other.

14. A method according to claim 9, wherein the projections (16) are formed in such a way that by bending each rotor lamination (12, 14), a ring having recesses (20) is created, the recesses (20) being formed between the projections (16) and being open radially towards the inside and closed towards the outside, and that rotor magnets are inserted into the recesses (20).

15. A method according to claim 9, wherein the rotor laminations (12, 14) are first stacked and then bent to form a rotor body.

16. A method for the manufacture of the rotor of an electric machine having a shaft (38; 52) and a rotor body that is manufactured by the steps:
providing at least one rotor lamination (12, 14) that is formed in the way of a strip having a series of projections (16) along the longitudinal edge (11) of the strip (12, 14);
bending the rotor lamination (12, 14) in the plane of the strip to form a ring, the projections (16) extending inwards after bending and the ring having a substantially unbroken outside edge
wherein splines (54; 56) are formed on the outside circumference of the shaft (38; 52) and the rotor body is wound about the shaft (38; 52), the projections (16) of the rotor body engaging into the splines (54; 56) of the shaft (38; 52).

17. A rotor according to claim 9, wherein splines (54; 56) are formed on the shaft (38) or on a member (50) that is mounted on the shaft (52).
